(19) United States
(12) Patent Application Publication
(10) Pub. No.: US 2004/0036663 A1
(43) Pub. Date: Feb. 26, 2004

(54) System and method for an image reader with electronic travel

(76) Inventors: David R. Bevers, Waterloo (CA); Peterson Borge, Elmira (CA)

Correspondence Address: Grant W.C. Tisdall, Suite 4900, Commerce Court West, Toronto, ON, M5L 1J3, CA

(21) Appl. No.: 10/453,495

(22) Filed: Jun. 4, 2003

Related U.S. Application Data
(63) Continuation of application No. PCT/CA03/00361, filed on Mar. 17, 2003.
(60) Provisional application No. 60/368,622, filed on Mar. 29, 2002.

(51) Int. Cl. G09G 5/00

(52) U.S. Cl. 345/7

(57) ABSTRACT

An image reader apparatus for modifying a visual characteristic of a document, the apparatus comprising: a frame; a table coupled to the frame and adapted to position the document for viewing; an imager assembly having an addressable image array adapted to produce a digital image of a selected portion of the document positioned on the table, the addressable array having a programmable pixel group; a lens assembly adapted to focus the selected portion on the pixel group of the array; a processor for monitoring the relative spatial position of the document with respect to the imager assembly, the processor for coordinating the position of the pixel group within the array; a display coupled to the processor and adapted to receive the digital image communicated by the imager assembly; wherein movement of the pixel group within the array provides for movement of the selected portion over the surface of the document.

This application is a continuation of International Application No. PCT/CA03/00361, filed Mar. 17, 2003 and now pending, which claims the benefit of Provisional Application No. 60/368,622, filed Mar. 18, 2002.

### FIELD OF THE INVENTION

The present invention relates to optical instruments and to visual enhancement of documents and graphic images.

### BACKGROUND OF THE INVENTION

There are a variety of optical instruments that can be used to enhance or otherwise facilitate the visual inspection of documents by a user with vision impairment, which can be caused by a variety of factors such as age, accidents, and hereditary diseases. Visually impaired persons need to look at many different documents during their daily activities, such as for writing checks, reading pill bottles, browsing newspapers, and other printed media. One such enhancement device for facilitating the visual inspection of documents is an image reader, which typically consists of a moveable table with an image projection system. The user positions the document on the table and then a projection device, such as a camera, captures an image of the document and then displays this image on a screen. The visual characteristics of the image can be modified, such as the brightness and magnification levels. However, considerable discomfort to the user can be encountered due to excessive table travel where high levels of magnification are required to view the document.

Accordingly, one of the fundamental problems with using a traditional X/Y reading table is that control of the subject text requires excessive movement of the reader table for high levels of magnification. This can result in the user needing a large footprint in which to read a document, due to the physical travel requirements of the table. This required high range of motion can interfere with the ergonomics of reading, and often causes physical interference with the user who needs to sit adjacent to the display. Therefore, one disadvantage with traditional readers is that physical table travel is needed to selectively view all parts of the document at high magnification levels.

It is an object of the present invention to provide an image reader to obviate or mitigate at least some of the above-presented disadvantages.

### SUMMARY OF THE INVENTION

According to the present invention there is provided an image reader apparatus for modifying a visual characteristic of a document. The apparatus comprises:

a) a frame;

b) a table coupled to the frame and adapted to position the document for viewing;

c) an imager assembly coupled to the frame and having an addressable image array adapted to produce a digital image of a selected portion of the document positioned on the table, the addressable array having a programmable pixel group;

d) a lens assembly coupled to the frame and adapted to focus the selected portion on the pixel group of the array;

e) a processor for monitoring the relative spatial position of the document with respect to the imager assembly, the processor for coordinating the position of the pixel group within the array; and

f) a display coupled to the processor and adapted to display the digital image communicated by the imager assembly;

wherein movement of the pixel group within the array provides for electronic movement of the selected portion over the surface of the document.

### BRIEF DESCRIPTION OF THE DRAWINGS

These and other features of the preferred embodiments of the invention will become more apparent in the following detailed description in which reference is made to the appended drawings wherein:

FIG. 1 is a perspective view of an image reader;

FIG. 2 is a side view of the image reader of FIG. 1;

FIG. 3 is a functional block diagram of the image reader of FIG. 1;

FIG. 4 is an exploded view of the image reader of FIG. 1;

FIG. 5 shows the displacement of the reader table of FIG. 1; and

FIG. 6 is a flow chart of the operation of the reader of FIG. 1.

### DESCRIPTION OF THE PREFERRED EMBODIMENTS

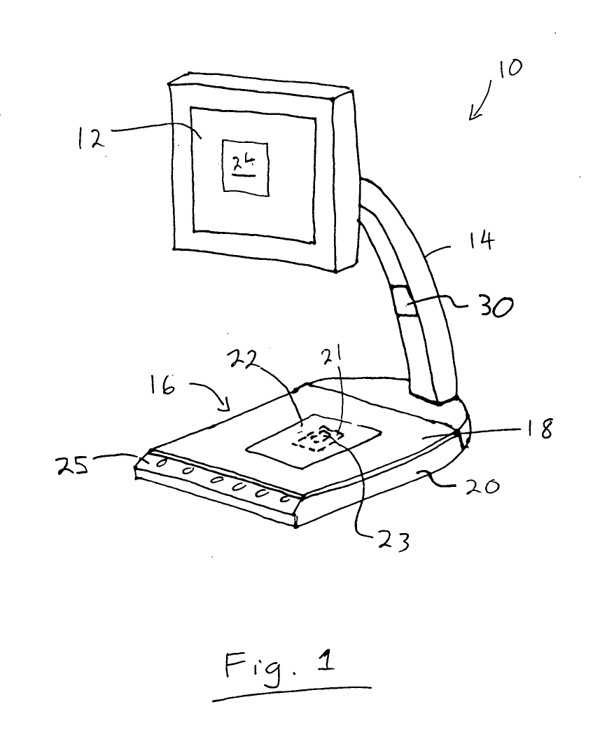

Referring to FIG. 1, an image reader 10 for enhancing the visual capabilities of a user includes a display 12 mounted on an arm 14, which is fixed to a support frame 16. The support frame 16 includes a movable table 18 that can be displaced manually or automatically by the user with respect to a base 20. A series of interface controls 25 are located on the base 20 for assisting the user in operation of the image reader 10 to interactively modify and then project selected portions 23 of a document 22 as an enhanced document 24 on the display 12. It is recognised that the selected portion 23 can also be referred to as a subset of a field of view or view window 21, which could include the whole document 22 surface, if desired. It is also recognised that the interface controls 25 could be used to control the movements of the table 18, if desired.

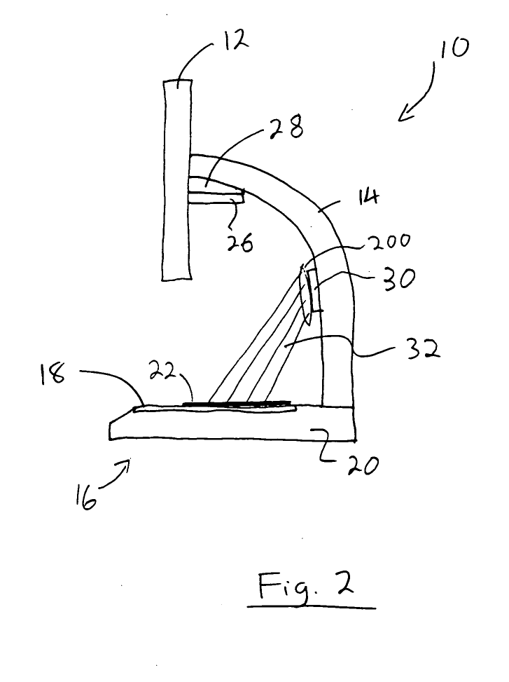

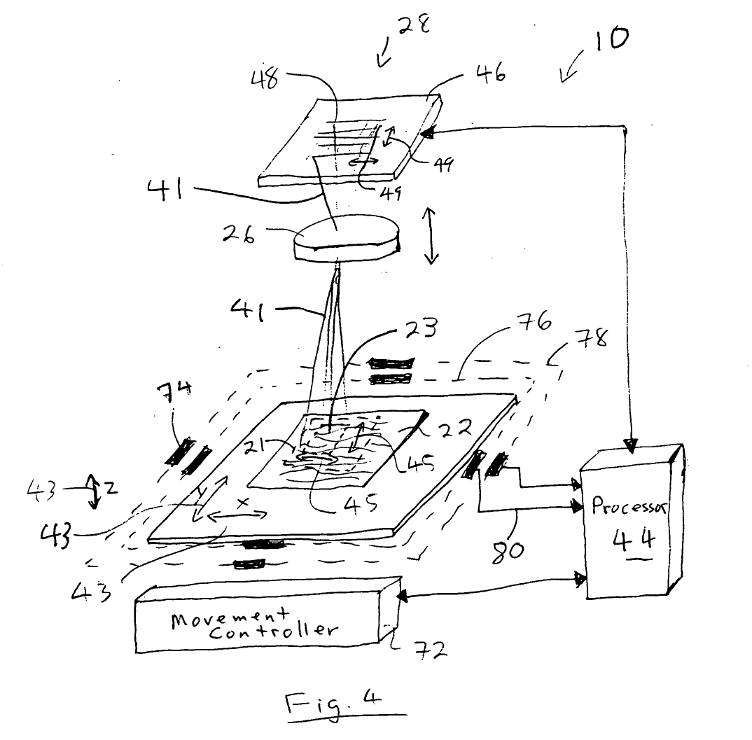

Referring to FIG. 2, the image reader 10 also includes a lens assembly 26 for focussing the selected portion 23 of the document 22 through refraction/reflection onto a CMOS imaging assembly 28. The magnification level of the lens assembly 26 helps to define the size of the selected portion 23 as a fraction of the total document 22 surface area. Accordingly, a magnification level of 1X would give the selected portion 23 as the same size as the document 22, as long as the physical size of the document 22 allows positioning of the document 22 within the complete field of view or view window 21 (see FIG. 4) of the lens assembly 26 at the lowest magnification levels. Once the magnification level of the lens assembly 26 is chosen to establish the view window 21, the user then proceeds to physically displace the document 22 on the table 18 relative to the imager assembly 28 so that the selected portion 23 moves across the surface of the document 22. It should be noted that for prior art image readers operating under magnification, the dimensions of the selected portion 23 coincide with the dimensions of the view window 21.

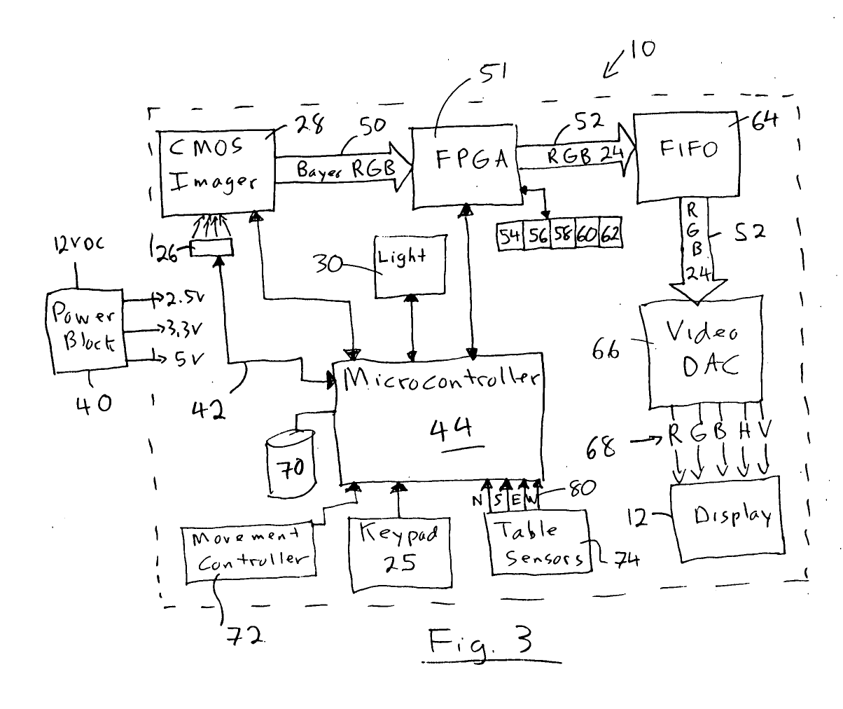

Referring to FIGS. 2 and 4, an illumination device 30 is used to project light 32 onto the selected portion 23 of the document 22 to assist in capturing by the CMOS imaging assembly 28 an image of the document 22 represented by the selected portion 23. It is recognised that the document 22 could also be backlit, if desired. Accordingly, the user can physically displace the movable table 18 to position the document 22 in a selected spatial location in relation to the imager assembly 28, which captures the selected portion 23 of the document 22 through the lens assembly 26 and converts the visual representation of the selected portion 23 to a digital image 50 (see FIG. 3). The digital image 50 is then dynamically processed by a processor 44 (see FIG. 3) and displayed as the enhanced document 24 on the display 12. The user with visual impairment can manipulate the interface controls 25 for modifying the visual depiction of the selected portion 23 to assist in visual inspection of the enhanced document 24. The modifications can include such as but not limited to further magnification and changes in contrast, colour, and text aspect ratio. It should be noted that the imaging assembly 28 coordinates with placement of the document 22 on the table 18 to provide a real-time dynamically enhanced image 24 on the display 12. the digital processing capabilities of the processor 44 help to dynamically modify the raw digital image 50 of the selected portion 23, as the selected portion 23 is scrolled by the user over the surface of the document 22.

Referring to FIG. 3, a block diagram of the image reader 10 gives the functional relationship between the various components. Power is supplied to the image reader 10 through a power block 40, which directs the various voltage levels required to the respective components. The lens assembly 26 includes, as is known in the art, such as but not limited to: an objective lens for acquiring or capturing the selected portion 23 within the field of the objective lens; and a lens control which can provide fixed focus, or can dynamically focus and control operation of the iris in conjunction with commands 42 provided by the processor 44. Further, a pinhole lens could also be used in place of the objective lens, if desired. It is also recognised that the lens control could also be done manually, if desired.

The imager assembly 28 contains a high-resolution digital image sensor (see FIG. 4), which can be controlled by the processor 44 to selectively provide pixel groups 48 within the sensors programmable and addressable pixel array 46. Accordingly, the imager assembly 28 can be instructed by the processor 44 as to which series of active pixel groupings or viewing areas 48 are selected from the total available pixels of the array 46. It is noted that one such sensor with addressable array capabilities is a Complementary Metal Oxide Semi-conductor (CMOS), however any other imager assembly 28 containing a sensor with addressable arrays would also be suitable. This programmable reassignment of the size and/or location (see arrows 49 of FIG. 4) of the pixel group 48 within the array 46 provides for an electronic enlargement of the travel capabilities of the selected portion 23 on the document 22 (i.e. electronic travel), without requiring a change in the relative physical positioning of the table 18-with respect to the base 20 (i.e. mechanical travel).

Accordingly, the boundaries of the view window 21 for the selected portion 23 can be considered relative to the boundaries of the pixel grouping 48 as defined by the borders of the array 46. This physical versus effective area relationship between the portion 23 to window 21, corresponding to the group 48 to the array 46, is 1:1 for no electronic travel by the imager assembly 28 for a selected magnification supplied by the lens assembly 26. Alternatively, this ratio is 1:N for addressable arrays 46 wherein the overall dimensions of the active pixel group 48 is less than the overall dimensions of available pixels in the array 46. It is recognised that the value of N is limited only by the size of the array 46 with respect to the group 48. Accordingly, an effective electronically controlled motion, referred to by arrows 49, of the imager assembly 28 helps to reduce the magnitude of mechanical travel capabilities of the table 18, referred to by arrows 43 (see FIG. 4). This combination of effective electronic and mechanical travel provides the view window 21 of the image reader 10 that is larger than the selected portion 23. It is also recognised that the view window 21 could be provided by solely electronic travel of the selected portion 23 over the surface of the document 22.

Further, it is noted that displacement of the table 18 can lead to blurred images of the enhanced document 24 when shown on the display 12 at higher magnification levels, when the sampling rate of the imaging assembly 28 is too low in relation to the rate of change of the displacement. Accordingly, the frame rate of the imager assembly 28 is preferably in the range of 40 to 70 frames per second, preferably 40 to 50 fps to accommodate for the blurring issue, which is more than double the traditional sampling rate of current high performance addressable sensors used for still picture applications, such as but not limited to a 1.3 Megapixel CMOS.

The illumination device 30 for the imager assembly 28 provides light rays 32 onto the document 22. The light rays 32 can be focussed to impinge on the selected portion 23, the view window 21, or to illuminate larger portions of the document 22 if desired. The illumination device 30 is used to saturate the imager assembly 28 with light so as to facilitate the capture of the digital image 50. One variable in determining a sufficient intensity of light for image 50 capture is the reflectivity of the document 22 surface, which could produce glare (oversaturation of the pixels of the pixel group 48) under excessive light intensities in relation to the surface reflectivity and therefore degrade the quality of the captured digital image 50. Another variable in determining sufficient light intensities is the ambient lighting conditions. The intensity of the light rays 32 should be higher than that provided by the ambient conditions to reduce the affect of insufficient light intensity on the quality of the captured image 50. One illumination device 30 is such as but not limited to an array of high intensity LEDs that provide an effectively instant on/off operation, as well as fixed light levels when activated. A range of light intensity for typical document viewing is 50 to 400 ft-candles, preferably in the range 100 to 200. A further consideration for the illumination intensity is the employed sampling rate of the imager assembly 28 for the image reader 10. Therefore, for increased sampling rates, an increased intensity of the illumination device 30 is used to provide adequate saturation of the imager assembly 28 so as to produce an acceptable quality of the digital image 50 to facilitate processing through an Field Programmable Gate Array (FPGA) 51.

Referring to FIG. 2, it is also recognised that the illumination device 30 can use focussing lenses 200 positioned in front of the LEDs to control the light intensity projected by the light rays 32 onto the document 22. For example, the focussing lenses could be approximately a 10 degree focussing lenses.

Accordingly, the light intensity of the illumination device 30 is optimised so as to minimise glare and to maximise the saturation level of the imager assembly 28, so as to provide for acceptable lighting quality of the captured digital image 50 at enhanced magnification levels of the document 22. A further example of the illumination device 30 is a fluorescent light. It is recognised that the intensity level of the illumination device 30 could be adjusted through focussing (by the lenses) and brightness of the light rays 32, which could be performed by the processor 44 and/or manually by the user.

Once the image assembly 28 has captured the digital image 50 of the selected portion 23, the digital image signal is directed into the FPGA 51 which acts as an electronics module to process to otherwise enhance the visual characteristics of the image signal 50 to produce a modified or otherwise image signal 52. These image enhancements are processed through the processor 44, and can be done by such as but not limited to a polarity reversal processing unit 54, a brightness processing unit 56, a colour processing unit 58, a contrast processing unit 60, and a magnification unit 62. It should be noted that all of these processing units could be represented as software modules stored on a computer readable medium 70 and run on the processor 44, or as individual hardware components, or a combination thereof.

The polarity reversal processing unit 54 can be used to perform a polarity reversal operation on the image signal 50. First, the signal 50 is converted into a black and white image and then all black pixels are inverted to white pixels and vise versa. The polarity reversal process can permit people with low vision to read light text on a dark background, as most printed material is available as dark text on a light background.

The brightness processing unit 56 performs brightness operations on the signal 50, by increasing or decreasing the mean luminance of the signal 50. This feature can be used by persons who experience excess brightness with a disproportionate impact on their contrast sensitivity, and/or for other viewing situations as will occur to those skilled in the art.

The colour processing unit 58 is used to remove the colour out of the signal 50 to produce an intermediate gray scale signal, as is known in the art. The intermediate signal can be enhanced by the contrast stretching unit 60, described below, and then the colour unit 58 then applies appropriate known interpolation routines to reblend the enhanced gray scale image back to the enhanced colour image signal 52. Other functions of the colour unit 58 could be to reformat the digital image 50 into other user selected or predefined colour combinations, such as yellow text on a blue background.

The contrast stretching unit 60 helps the user to perform a contrast stretch or to make a contrast adjustment to a specific range of brightness or luminance of the signal 50. The contrast stretching unit 60 performs the contrast stretch of the range between the darkest and lightest parts of the signal 50 above a threshold value, such as a mean or median value selected from the range. The unit 60 can be used when the user wishes to discern two or more relatively dark shapes against a bright background, or when two or more relatively bright shapes are present against a black background. This thresholding operation is accomplished by performing a dynamic determination on a pixel by pixel basis of making dark gray pixels darker and light gray pixels lighter until an adequate amount of contrast in the signal 50 is achieved, in response to an appropriate user preference. For example, all pixels represented in the image signal 50 below a certain threshold value would be modified and then reproduced as black pixels, while those pixels above the threshold value would be modified and represented as white pixels in the modified signal 52. Accordingly, the degrees of shading levels between the black and white designations of the pixels can be reduced or otherwise effectively eliminated to provide a cleaner enhanced image 24 over the original captured image signal 50. It is recognized that other pixel shading can be used than black/white designations, such as but not limited to darker colours with white or lighter colour variations to produce a contrasted enhanced image 24. Further, the user can control the amount of contrast stretch dynamically through the interface controls 25, in order to provide the enhanced image 24 to a user specified specification. This helps to tailor the enhanced image 24 to the individual situation. It is noted that the resolution of the image signal 52 can be degraded by this process, but contrast quality can be improved.

Further, it is also recognised that the thresholding operation is performed dynamically for each newly acquired selected portion 23 presented to the pixel array 46 of the digital sensor of the imager assembly 28. The visual characteristics of the raw image signal 50 represented by the selected portion 23 can be variable during operation of the reader 10, due to electronic travel, mechanical travel, and/or changes in lighting intensity reflected by the document 22 onto the imager assembly 28. These variations can dynamically change the visual characteristics as captured by each pixel of the pixel grouping, however, are subsequently adjusted by the thresholding operation before the enhanced image 24 is displayed on the display 12.

The stretching unit 60 can also be used to perform a spatial stretch whereby one direction of the image is held constant (X direction) while the other direction is effectively stretched by filling in every second pixel of the digital image 50. This algorithm produces a modified image 52 in which the width of, for example, character text remains constant while the height of the text is increased. It is recognised that other combinations of spatial direction (1′ constant—X stretched, or Y stretched—X stretched) can be performed, if desired. It is also recognised that fill frequencies other than every second pixel could be performed, if desired.

The magnification processing unit 72 allows the user to electronically decrease or increase the magnification of the digital image 50, as desired. The processing unit 72 can interact with the physical magnification provided by the lens controller to cause the lens of the lens assembly 26 to zoom in or zoom out on the selected portion 23 of the document 22. The magnification of digital image 52 can also be accomplished by digital processing of the digital image 50 by the processor 44. Accordingly, magnification processing unit 72 can perform a conventional digital magnification, in order to increase or decrease the size of the digital image 50 to produce the modified signal 52.

The modified image 52 is then read in to a register 64, for example a FIFO, which can be employed as a buffer to synchronise the delivery of the modified signal 52 to the display 12. The imager assembly 28 uses variable frequencies to account for changes in area of the selected portion 23. Accordingly, the register 64 is used to synchronise the delivery of the modified signal 52 in response to the variability in the imager assembly 28 frequencies. Further, video digital to analogue converter (DAC) 66 can be used to produce an analogue signal 68 representing the enhanced image 52 to the display 12. As described above, the processor 44 controls the modification of the captured digital image 50 to produce the modified signal 52. The processor 44 can be coupled to the display 12 through the FPGA 51. Control of the FPGA 51 can be accomplished through the interface controls 25, such as a keyboard, mouse, or other suitable devices. If the display 12 is touch sensitive, then the display 12 itself can be employed as the user input device 25. A computer readable storage medium 70 is coupled to the processor 44 for providing instructions to the processor 44, in order to instruct and/or configure the various image reader 10 components to perform steps or algorithms related to the operation of the imager assembly 26, lens assembly 28, and image modification of the captured digital image 50 to produce the modified signal 52. The computer readable medium 70 can include hardware and/or software such as, by way of example only, magnetic disks, magnetic tape, optically readable medium such as CD ROM's, and semiconductor memory such as PCMCIA cards. In each case, the medium 70 may take the form of a portable item such as a small disk, floppy diskette, cassette, or it may take the form of a relatively large or immobile item such as hard disk drive, solid state memory card, or RAM. It should be noted that the above listed example mediums 70 can be used either alone or in combination.

Referring to FIGS. 3 and 4, the processor 44 is also coupled to a movement controller 72 for effecting the movement of the table 18 with respect to the base 20, identified by arrows 43. Preferably, the table 18 is physically displaced 43 in any combination of directions X and Y by the movement controller 72 so as to locate the physical position of the view window 21 on a desired region of the document 22. In comparison, the electronic positioning of the selected portion 23 within the view window 21 is shown by the arrows 49. The physical movement 43 provided by the controller 72 can be a series of such as but not limited to mechanical gears, belts; linkages, guides, or any other equivalent displacement devices, either manual and/or motorised, that would be apparent to one skilled in the art. It is noted that active control of the movement controller 72 by the processor 44 may not be necessary in the case of manual direction of the table 18 by the user. It is further noted that the table 18 could also be displaced in the Z direction with respect to the base 20, in combination with the above note X and Y directions, if desired.

The movement of the table 18 is also monitored by a series of motion sensors 74, which sense the magnitude of displacement in a selected direction in the X-Y coordinate system relative to the base 20. The motion sensors 74 are arranged in a staggered sequence about the base 20, represented by such as but not limited to a series of bounding boxes 76, 78 to facilitate the motion detection in a graduated fashion. Further, the motion sensors 74 can also be used to detect a rate of change in the displacement, velocity and/or acceleration, if desired. The displacement characteristics of the table 18 are communicated to the processor 44 through displacement signals 80. These signals 80 are employed by the processor 44 to dynamically determine the selection of the active pixel group 48 from the total available pixels of the addressable pixel array 46, as will be further explained below. The electronically controlled travel 49 of the pixel group 48 helps to coordinate the effective travel of the selected portion 23 over the document 22 surface, while minimising corresponding physical travel 43 of the table 18 with respect to the imager assembly 28. The effective travel of the selected portion 23 is referenced by arrows 45, a combination of the electronic travel 49 and physical travel 43. The type of motion sensors 74 that can be used with the image reader 10 are such as but not limited to pressure sensors, proximity switches, hall sensors, and other equivalent displacement sensors as are known in the art. It is further recognised that the frequency of receipt by the processor 44 of sensor signals 80 for a sequence of adjacent sensors 74 could be used by the processor 44 to determine rate of change of the monitored table 18 displacement.

It is also recognised that the sensors 74 can be digital encoders for monitoring the physical travel of the table 18. Referring to FIG. 4, in this case the position signals 80 could be digital displacement signals received by the processor 44 from the digital encoders 74. The signals 80 could be used in a feedback loop to adjust the calculated electronic travel based on the magnitude of the mechanical travel, and/or velocity and/or acceleration information pertaining thereto. It is also recognised that the sensors 74 could also be analogue position sensors 74 such as switches and/or optical encoders that would supply the corresponding digital signals 80 though an A to D converter (not shown). Therefore, the intended mechanical travel initiated by the user is used to generate a corresponding magnitude of electronic travel to provide the desired total magnitude of motion.

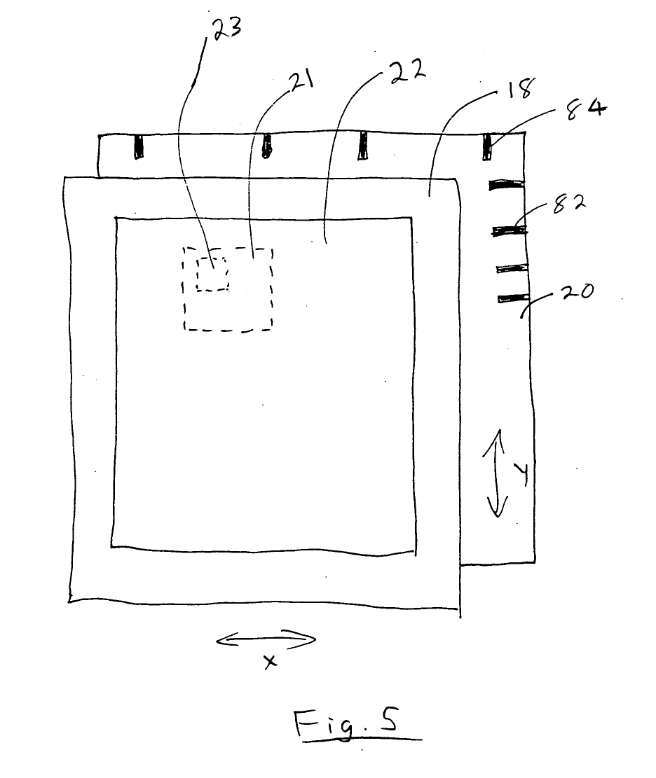

Further, in reference to FIG. 5, a series of releasably securable vertical locks 82 and horizontal locks 84 can be employed to restrict the table 18 movement to a predefined and/or selected displacements in the X and Y directions respectively. For example, the movement of the table 18 in the Y direction can be restricted temporarily by chosen ones of the locks 82, so as to assist a user to read a document in a left to right traversal of text. Once a particular line of text is finished by the user, the current vertical lock 82 would be released, the document 18 displaced by the user for one row in the Y direction, and then the next vertical lock 82 engaged so as to facilitate the reading of the next row of text in a left to right fashion. It is recognised that a similar sequencing of table 18 movement could be controlled by the horizontal locks 84 for the traversal of the document 18 in a column by column fashion. The locks 82, 84 can be controlled manually by the user and/or dynamically by the processor 44 in relation to user defined travel through the interface controls 25, and/or in relation to the sensor signals 80 provided by the motion sensors 74. Furthermore, these locks 82, 84 could be mechanical, electrical, or a combination thereof.

Referring to FIGS. 4 and 5, the image reader 10 employs the reduced motion table that is electronically coupled to the processor 44, which simultaneously controls placement of the pixel group 48 within the array 46 in response to intended or actual table 18 movement. Accordingly, the required displacement of the table 18 in the X, Y direction(s) is reduced, or possibly eliminated, with the additional control of the adjustable pixel group 48 of the imager assembly 28, thereby providing a range of effective motion given by the view window 21. Therefore, the effective motion 45 of the selected portion 23 on the table 18 is M=T+SC, where M is the effective motion 45, T is the physical table travel 43, and SC is the imager assembly 28 scan distance 49. The motion sensors 74 are used as indicators or triggers by the processor 44 to keep track of the physical displacement of the table 18.

Accordingly, once the pixel grouping 48 has electronically travelled 49 to the boundary of the array 46, preferably with minimal physical table 18 travel 43, the selected portion 23 has travelled to the corresponding boundary of the view window 21 on the document 22. At this stage, the physical motion of the table 18 is relied upon, monitored by the sensors 74, to allow repositioning of the pixel grouping 48 away from the boundary of the array 46, which correspondingly moves or resets the physical position of the view window 21 on the document 22. It is recognised that alternatively, the physical motion 43 could be used first to travel 45 the view window 21 to result in having the selected portion 23 contact the boundaries of the view window 21. Then the electronic travel 49 could be used to reset the location of the pixel group 48 within the array 46, and thereby move the selected portion 23 away from the boundary and within the view window 21 in the direction initiated by the table 18 travel 43. Further, any combination of physical travel 43 with electronic travel 49 could be used to effect the travel 45 of the selected portion 23 within the view window 21. Therefore, the physical travel 43 is used to move the physical location of the view window 21 with respect to the surface of the document 22, if required to view the regions of the document 22 under the magnification level selected by the user.

Accordingly, in the above-described reassignment of the pixel group 48, the processor 44 interfaces with the array 46 so as to update the rows and columns of the pixels, which electronically displaces the position of the pixel grouping 48 to cover the next region of the document 22 along the sensed direction of travel of the table 18. This pixel update is coordinated with the minimised physical displacement of the table 18, as detected by the motion sensors 74. For example, the boundaries that trigger the reassignment of the pixel grouping 48 can be the bounding boxes 76, 78. The sequence of changing the addressing of the pixels in the array 46 can be performed in a controlled manner, such that a smooth scrolling is provided of the enhanced document 24 shown on the display. This smooth scrolling helps to maintain the continuity to the user of their position in the document 22 during the effective change in the position of the selected portion 23 within the view window 21; as the physical displacement of the table 18 is relied upon. The rate of change of reassigning the addresses of the pixel grouping 46 can be fixed or predefined, user selectable through the interface controls 25, and/or responsive to the displacement rate of change information supplied to the processor 44 by the motion sensors 74. For the example of reading text, the addressing of the imager assembly 28 by the processor 44 could be performed in a row by row sequential displacement of the field of view of the array 46.

It is further recognised that a small degree of mechanical travel portion T can be sensed and quantified by the motion sensors 74 to provide a motion signal 80 to the processor 44. the motion signal 80 includes the magnitude of the mechanical travel sensed. The processor in turn could calculate a corresponding substantially simultaneous electronic travel portion SC, such that the magnitude of the mechanical travel portion T is less than the magnitude of the calculated electronic travel portion SC. For example, a representative relatively minor physical travel of the table 18 could be amplified greatly by the calculated electronic travel, thus providing the desired effective motion 45 mainly by electronic manipulation of the selected portion 23 over the surface of the document 22. The relatively small magnitude of the mechanical travel of the table 18, compared to the larger degree of electronic travel, can be usd to provide the user of the image reader 10 with a familiar ergonomic sense of the direction and location of the document 22 movement. Accordingly, the provision of minimised mechanical travel of the table 18 can help the user to maintain a reference (location and/or direction) of the document 22 as compared to the displayed enhanced image 24 on the display.

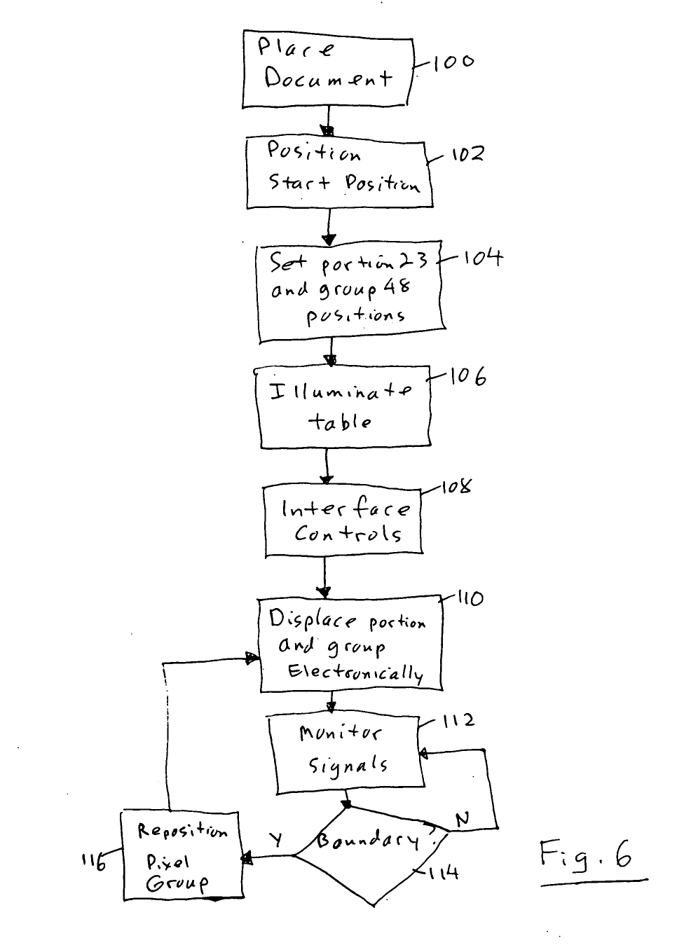

Referring to FIGS. 4, 5, and 6, operation of the image reader 10 is initiated by fixing 100 the document 22 on the table 18 so that relative movement between the document 22 and the table 18 is discouraged. The table 18 is then positioned 102 so that the document 22 is placed in an initial starting position, such as but not limited to the upper left hand corner for reading of text and the lens assembly 26 is focused. This procedure sets the physical location 104 of the view window 21 with the electronic position of the pixel grouping 48 within the array 46. The table 18 is then illuminated 106 by the illuminator device 30 to facilitate the capture of the digital image 50 by the imager assembly 28. The user then adjusts 108 the interface controls 25 to modify the visual characteristics of the image 50 to produce the enhanced image 24 shown on the display 12.

The processor 48 then adjusts 110 the relative electronic spatial position of the pixel group 48 of the imager assembly 28, with respect to the array 46, by starting or intending to move 43 the table 18 in a selected direction. This causes scrolling 45 of the selected portion 23 over the document 22 surface with minimal table 18 physical travel, by relying upon the electronic travel 49. The user can look at the enhanced image 24 of the document 22 as displayed on the display. As the scrolling 45 proceeds, the processor 44 monitors 112 the motion signals 80 to help determine the intended direction of the table 18 travel and allows the pixel group 48 to electronically traverse across the array 46. In the event the boundary of the array 46 is reached 114 by the pixel group 48, the processor 44 proceeds to reassign 116 the pixels of the pixel group 48 according to the now relied upon physical table 18 motion to move the view window 21 over the document 22. The processor 44 processes the signals 80 to coordinate electronic travel 49 of the pixel group 48 with the physical travel 43 of the table 18, if required. Once the pixel group 48 has been repositioned within the array 46, corresponding to the view window 21 repositioning, the physical travel 43 of the table is minimised and the displacement 45 of the selected portion 23 over the surface of the document 22 is done electronically 49 by the imager assembly 26. It is recognised that any combination of electronic travel 49 and physical travel 43 can be used to traverse 45 the selected portion 23 within the view window 21 and therefore over the surface of the document 22 located on the table 18. It is also recognised that the magnitude of electronic travel 49 can be maximised with respect to the magnitude of the physical travel 43, including the limit fo complete electronic travel 49 with no physical travel 43 or relatively little electronic travel as compared to almost complete physical travel 43.

It is further recognised in the above embodiments, for operation of the image reader 10, that movement of the table 18 was described with respect to the base 20. Alternatively, the imager assembly 28 and associated lens assembly 26 could be moved relative to the table 18, or a combination of table 18 movement and assembly 26, 28 movement could be employed to effect a relative displacement of the table 18 with respect to the assembly 26, 28. Furthermore, the potential for movement of the table 18 and/or assembly 26, 28 could be removed, in situations where solely the electronic control of the pixel group 48 within the array 46 is sufficient to traverse the selected portion 23 over the desired areas of the document 22. Accordingly, it is contemplated that the view window 21 could be at least the same size as the desired view areas of the document 22, so as to provide complete movement 45 of the selected portion 23 within the window 21 under electronic travel 49. Additionally, the size of the document 22 on the table 18 could be detected and used by the processor 44 to coordinate the simultaneous positioning of the view window 21, through travel 43, with electronic positioning 49 of the pixel group 48, so that the selected portion 23 continuously travels 45 in a chosen X-Y direction from one side of the view window 21 to the other as the entire extent of the document 22 is viewed by the user on the display 12. Further, it is recognised that other documents such as those containing graphical images could be viewed by the imager reader 10.

Although the invention has been described with reference to certain specific embodiments, various modifications thereof will be apparent to those skilled in the art without departing from the spirit and scope of the invention as outlined in the claims appended hereto.

The embodiments of the invention in which an exclusive property or privilege is claimed are defined as follows:

1. An image reader apparatus for modifying a visual characteristic of a document, the apparatus comprising:
a) a frame;
b) a table coupled to the frame and adapted to position the document for viewing;
c) an imager assembly coupled to the frame and having an addressable image array adapted to produce a digital image of a selected portion of the document positioned on the table, the addressable array having a programmable pixel group;
d) a lens assembly coupled to the frame and adapted to focus the selected portion on the pixel group of the array;
e) a processor for monitoring the relative spatial position of the document with respect to the imager assembly, the processor for coordinating the position of the pixel group within the array; and
f) a display coupled to the processor and adapted to display the digital image communicated by the imager assembly;
wherein movement of the pixel group within the array provides for electronic movement of the selected portion over the surface of the document.

2. The apparatus of claim 1 further comprising a motion system configured for providing relative mechanical movement between the spatial position of the imager assembly and the spatial position of the table.

3. The apparatus of claim 2, wherein the electronic movement and the mechanical movement are combined to provide an effective movement of the digital image on the display.

4. The apparatus of claim 3 further comprising a sensor for monitoring the relative mechanical movement between the imager assembly and the table.

5. The apparatus of claim 4, wherein the sensor is a digital encoder.

6. The apparatus of claim 4, wherein a degree of the mechanical movement sensed by the sensor is used by the processor to calculate a corresponding degree of the electronic movement.

7. The apparatus of claim 6, wherein the degree of electronic movement is greater than the degree on mechanical movement.

8. The apparatus of claim 2 further comprising an illumination device for providing a sufficient degree of illumination to saturate the pixels of the pixel group.

9. The apparatus of claim 8, wherein the sufficient degree of illumination is greater than ambient lighting conditions surrounding the table.

10. The apparatus of claim 8, wherein the illumination device comprises light emitting diodes.

11. The apparatus of claim 10, wherein the illumination device further comprises a lens for focussing the illumination of the light emitting diodes on the table.

12. The apparatus of claim 2, wherein the motion system moves the table.

13. The apparatus of claim 2 further comprising a contrast unit coupled to the processor, the contrast stretch unit for modifying the contrast properties of the digital image prior to display on the display.

14. The apparatus of claim 13, wherein the contrast unit uses dynamic thresholding for modifying the contrast properties.

15. The apparatus of claim 14 further comprising a threshold value.

16. The apparatus of claim 4, wherein the sensor is selected from the group comprising: pressure sensor; proximity switch; hall sensor; digital encoder; and optical encoder.

17. The apparatus of claim 16, wherein the sensor senses mechanical movement properties selected from the group comprising relative spatial position, velocity, and acceleration between the table and the imager assembly.

18. The apparatus of claim 2, wherein the mechanical movement and the electronic movement are added simultaneously to provide an effective simultaneous displacement of the digital image on the display.

19. The apparatus of claim 2, wherein the mechanical movement and the electronic movement are added sequentially to provide an effective sequential displacement of the digital image on the display.
